(19) United States
(12) Patent Application Publication
(10) Pub. No.: US 2017/0204837 A1
(43) Pub. Date: Jul. 20, 2017

(54) WIND TURBINE WITH DIRECTLY DRIVEN GENERATOR

(71) Applicant: SIEMENS AKTIENGESELLSCHAFT, 80333 München (DE)

(72) Inventor: ULRICH HARTMANN, Berlin (DE)

(73) Assignee: SIEMENS AKTIENGESELLSCHAFT, 80333 München (DE)

(21) Appl. No.: 15/326,916

(22) PCT Filed: Jul. 2, 2015
(86) PCT No.: PCT/EP2015/065073

§ 371 Date: Jan. 17, 2017

(30) Foreign Application Priority Data
Jul. 18, 2014 (EP) 14177660.9

(51) Int. Cl. F03D 15/20; F03D 9/25; H02K 7/18; F03D 80/70

(52) U.S. Cl. CPC F03D 15/20; F03D 80/70; F03D 9/25; H02K 7/1838; F05B 2230/60; F05B 2240/50; F05B 2220/7068

(57) ABSTRACT

A wind turbine system includes a wind turbine which has a wind turbine shaft rotatable around an axis, and a generator. The generator has shaft, a stator positioned on a machine housing, and a rotor interacting with the stator. The shaft of the generator and the wind turbine shaft are formed as one piece and/or are coupled to each other in axially aligned relationship. The wind turbine and the generator are mounted exclusively by two main bearings on the wind turbine shaft in a machine housing on top of a tower of the wind turbine system.

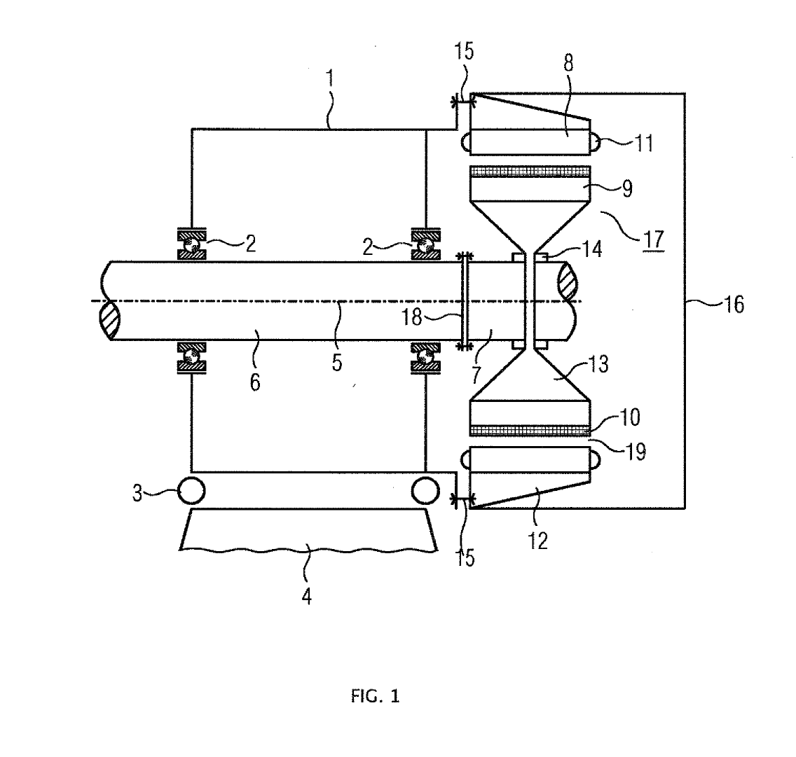

The invention relates to a wind turbine system comprising a generator and a support concept for supporting the wind turbine shaft, as well as a method for positioning a generator in the wind turbine system.

In wind turbine systems the generator is driven by way of a gearbox or directly by way of the wind turbine shaft. The generator can, when viewed in the direction of the wind, be arranged either in front of the tower (EP 2 164 154 A1), on the tower or behind the tower (EP 1 327 073 B1). A wide variety of support units can be used to brace the rotating components and to withstand a corresponding bending characteristic of the turbine shaft without damage.

Based on this, the object of the invention is to provide a generator concept for wind turbine systems, which cuts the support units to a minimum while at the same time ensuring technical reliability and cost-effectiveness.

The object is achieved by a wind turbine system comprising a wind turbine, which has a wind turbine shaft rotatable around an axis and a shaft of a generator, wherein the generator has a stator and a rotor, wherein the shaft of the generator and the wind turbine shaft are formed as one piece and/or are coupled to each other axially aligned, wherein the wind turbine and generator are supported exclusively by two main bearings on the wind turbine shaft in the machine housing at the top of the tower of the wind turbine system, and wherein the stator is positioned on the machine housing.

The object is also achieved by a method for mounting a generator on a wind turbine system comprising a wind turbine, which has a wind turbine shaft rotatable around an axis and a shaft of a generator, wherein the generator has a stator and a rotor, wherein the shaft of the generator and the wind turbine shaft are formed in particular as one piece or are coupled to each other axially aligned, wherein the wind turbine and generator are supported exclusively by two main bearings on the wind turbine shaft in the machine housing at the top of the tower of the wind turbine system, and wherein the stator is positioned on the machine housing, characterized by the following steps:
corresponding segments of stator and rotor are prefabricated and are provided in pairs, i.e. in each case a stator segment and a rotor segment with a transport securing device which in particular corresponds to the air gap of the subsequent generator,
assembly of the pairs of segments to form a generator at the base of the wind turbine, wherein the generator is then fixed as a whole to the axial extension of the wind turbine shaft,
fixing the stator segments to the machine housing of the wind turbine system and subsequently removing the transport securing devices of the pairs of segments.

The object is also achieved by a method for mounting a generator on a wind turbine system comprising a wind turbine, which has a wind turbine shaft rotatable around an axis and a shaft of a generator, wherein the generator has a stator and a rotor, wherein the shaft of the generator and the wind turbine shaft are formed in particular as one piece or are coupled to each other axially aligned, wherein the wind turbine and generator are supported exclusively by two main bearings on the wind turbine shaft in the machine housing at the top of the tower of the wind turbine system, and wherein the stator is positioned on the machine housing, characterized by the following steps:
corresponding segments of stator and rotor are prefabricated and are provided in pairs, i.e. in each case a stator segment and a rotor segment with a transport securing device which in particular corresponds to the air gap of the subsequent generator,
attaching the pairs of segments directly to the wind turbine shaft, wherein the generator ensues step by step on the axial extension of the wind turbine shaft,
fixing the stator segments to the machine housing of the wind turbine system and subsequently removing the transport securing devices of the pairs of segments.

The object is also achieved by a method for mounting a generator on a wind turbine system comprising a wind turbine, which has a wind turbine shaft rotatable around an axis and a shaft of a generator, wherein the generator has a stator and a rotor, wherein the shaft of the generator and the wind turbine shaft are formed in particular as one piece or are coupled to each other axially aligned, wherein the wind turbine and generator are supported exclusively by two main bearings on the wind turbine shaft in the machine housing at the top of the tower of the wind turbine system, and wherein the stator is positioned on the machine housing, characterized by the following steps:
the generator is prefabricated in the factory and is placed with a generator shaft or a support structure of the rotor and on site directly onto the axial extension of the wind turbine shaft,
fixing the stator to the machine housing of the wind turbine system.

According to the invention the generator is now, when viewed in the direction of the wind, arranged behind the tower without a separate support. In other words there are only two main bearings which hold, fix and support the wind turbine shaft. The stator of the generator is fixed to the machine housing axially and/or in the circumferential direction; the rotor is connected to the turbine shaft. The rotor is either positioned directly onto the extension of the turbine shaft or the rotor is flange-mounted with its own generator shaft axially onto the wind turbine shaft.

Advantageously the stator is fixed to the machine housing by way of an adjustable fastening, thereby significantly simplifying mounting in particular of a segmented generator and/or rotor segments. This is necessary so that the air gap of the generator can be adjusted easily and precisely. Before the generator is mounted on the system, transport devices position the location of the rotor in respect of the stator or the location of the rotor segments in respect of the respective stator segments. These transport securing devices are dismantled once mounting of the generator is completed.

The transport securing devices ensure a coaxiality of rotor and stator even without bearings. The generator can be mounted onto the turbine shaft e.g. by centering the rotor on the turbine shaft.

Both the rotor and the stator are preferably embodied in a segmented design, for example made of four segments in each case.

Advantageously the segments are provided in pairs. In other words, a stator segment and a rotor segment are supplied together as one unit, one advantage of which is that the permanent magnets on the rotor are already magnetically shielded by the stator.

According to the invention the corresponding segments can already be assembled on site to form a generator and subsequently attached axially to the turbine shaft at the top of the tower. Likewise it is possible to position individual segments of the generator in each case at the top onto the turbine shaft onto the respectively provided support structures.

This type of system strategy is in particular suitable for smaller and medium output wind turbines, e.g. 0.5 to 4 MW. Thanks to this inventive system concept, the absence of support for the generator means that the risk of a support failing is reduced, and cost-effectiveness is increased, since fewer bearing points mean lower costs and less manufacturing complexity. Likewise, because of the comparatively small number of bearing points, the cost of maintenance for the wind turbine system is reduced.

The invention and an advantageous embodiment of the invention can be taken from the FIGURE.

The FIGURE shows a partial longitudinal section of a wind turbine system (not shown in greater detail), wherein a torque provided by the wind turbine is supplied to a generator 17 by way of a wind turbine shaft 6, which rotates about an axis 5. The turbine shaft 6 is exclusively held and fixed on two main bearings 2, which are arranged in a machine housing 1. The machine housing 1 is braced on the tower by way of an azimuth bearing 3. The generator 17, which has rotor elements on a support construction 13, is located in an axial extension of the wind turbine shaft 6. The rotor 9 formed by the rotor elements has permanent magnets 10 pointing to an air gap 19 of the generator 17.

Said permanent magnets 10 can be attached as surface magnets or “buried magnets” to the rotor 9 or rotor segment. Surface magnets are magnets which are held on the surface of the rotor 9 or rotor segment by means of adhesive and/or banding. “Buried magnets” are magnets which are positioned in recesses which run essentially axially and which when viewed in the circumferential direction are closed, for example by resin or another preferably magnetically conductive casting compound.

A stator 8 is attached to the rotor 9 and air gap 19 by its winding system, which forms winding overhangs 11 on the end faces of the stator 8. The stator 8 is fastened to the machine housing 1 by way of a support structure 12. The whole generator 17 is outwardly shielded by a cover 16 in particular against effects of the weather.

Because of this inventive system concept it is now merely necessary to provide two main bearings 2, wherein the generator 17 is located in an axial extension of the wind turbine shaft 6. The directly driven generator 17 can already be assembled segment by segment on site. Likewise the individual segments of the generator 17 can be attached at the top directly to the turbine shaft 6 by way of the support structure 13 of the rotor 9 and the interface 14 to the turbine shaft 6.

Alternatively it is possible also to assemble a shaft butt 7, which is be regarded as a shaft of the generator 17, in the factory or on site and then to flange the entire generator 17 to the turbine shaft 6 by way of a shaft connection 18 necessary in this case. The stator 8 is then fixed to the machine housing 1 by way of its fastening 15.

In none of the embodiments does the generator 17 have a separate bearing.

What is claimed is:

1.-7. (canceled)

8. A wind turbine system, comprising:
a machine housing;
a wind turbine including a wind turbine shaft rotatable around an axis;
a generator including a shaft connected to the wind turbine shaft, and a stator positioned on the machine housing;
at least one adjustable fastening configured to secure the stator to the machine housing; and
two main bearings configured to support the wind turbine and the generator on the wind turbine shaft in the machine housing atop a tower of the wind turbine system.

9. The wind turbine system of claim 8, wherein the shaft of the generator and the wind turbine shaft are formed as one piece.

10. The wind turbine system of claim 8, wherein the shaft of the generator and the wind turbine shaft are coupled to each other in axially aligned relationship.

11. The wind turbine system of claim 8, wherein the generator includes a rotor interacting with the stator and having permanent magnets which point to an air gap of the generator.

12. The wind turbine system of claim 8, wherein the generator includes a rotor interacting with the stator, said generator being configured in segments in a circumferential direction of the generator, at least one of the stator and the rotor or both being configured in segments.

13. The wind turbine system of claim 8, wherein the generator is positioned on a side of the tower facing away from the wind turbine.

14. A method for mounting a generator onto a wind turbine system, comprising:
prefabricating corresponding segments of a stator and a rotor in pairs;
providing each stator segment and each rotor segment with a transport securing device;
assembling the pairs of stator and rotor segments so as to form a generator at a base of the wind turbine system;
fixing the generator as a whole to an axial extension of a wind turbine shaft;
fixing the stator segments to a machine housing; and
removing the transport securing devices from the pairs of stator and rotor segments.

15. The method of claim 14, wherein an air gap of the generator is formed as the transport securing devices are removed.

16. A method for mounting a generator onto a wind turbine system, comprising:
prefabricating corresponding segments of a stator and a rotor in pairs;
providing each stator segment and each rotor segment with a transport securing device;
attaching the pairs of stator and rotor segments directly to an axial extension of a wind turbine shaft step by step so as to form a generator;
fixing the stator segments to a machine housing; and
removing the transport securing device from the pairs of stator and rotor segments.

17. The method of claim 16, wherein an air gap of the generator is formed as the transport securing devices are removed.

18. A method for mounting a generator onto a wind turbine system, comprising:
prefabricating a generator in a factory;
attaching the generator to a generator shaft or a support structure of a rotor on site directly onto an axial extension of a wind turbine shaft; and
fixing a stator to a machine housing of the wind turbine system.
